(19) United States
(12) Patent Application Publication
(10) Pub. No.: US 2026/0017848 A1
(43) Pub. Date: Jan. 15, 2026

(54) METHOD AND SYSTEM OF RECOLORING ARTIFACTS BASED ON VARIOUS PARAMETERS

(71) Applicant: Microsoft Technology Licensing, LLC, Redmond, WA (US)

(72) Inventors: Ritika SRIRAM, Bangalore (IN); Nithin ISMAIL, Hyderabad (IN); Prachi AGGARWAL, Noida (IN); Vaibhav VERMA, Ghaziabad (IN); Preetika AGARWAL, Noida (IN); Aryan SINGH, Noida (IN)

(73) Assignee: Microsoft Technology Licensing, LLC, Redmond, WA (US)

(21) Appl. No.: 18/770,378

(22) Filed: Jul. 11, 2024

(51) Int. Cl. G06T 11/00

(52) U.S. Cl. CPC G06T 11/001; G06T 2200/24

(57) ABSTRACT

A system and method for automatically recoloring an artifact includes receiving the digital artifact and one or more input images and receiving a user query from a user interface screen of an application being executed on a user client device, to create a design that includes the digital artifact and the one or more input images. A prompt is then constructed via a prompt construction engine, for transmission to a generative artificial intelligence (AI) tool, the prompt requesting the generative AI tool to identify a plurality of colors based on the user query. The prompt is transmitted to the prompt to the generative AI tool and the plurality of colors is received from the generative AI tool. The plurality of colors are then transmitted to a base palette generation engine, the base palette generation engine generating a base color palette based on at least one of one or more colors of the one or more input images or the plurality of colors received from the generative AI tool. The digital artifact is recolored based on the base color palette.

### BACKGROUND

Many content creation application such presentation applications and design applications offer a diverse range of design templates or other digital artifacts that a user can utilize to create a document such as a presentation, flier, invitation, marketing material and the like. While the offered templates may provide some flexibility to users for generating documents, the pre-made templates may not cater to the interests of every user. Moreover, in many cases users are interested in adding other images or designs to a template and the user images, designs or preferred colors may differ from those used in the template, thus resulting in an incoherent or undesired color scheme in the final design. This limits the user's choices for design creation, resulting in the need to search for different templates and/or images and leading to user frustration and dissatisfaction. This is exacerbated when the user has multiple images and/or color schemes to use, or the user does not know which colors to choose to create an aesthetically pleasing design.

Hence, there is a need for improved systems and methods of recoloring artifacts based on various parameters.

### SUMMARY

In one general aspect, the instant disclosure presents a data processing system for automatically recoloring a digital artifact, the data processing system having a processor and a memory in communication with the processor wherein the memory stores executable instructions that, when executed by the processor alone or in combination with other elements, cause the data processing system to perform multiple functions. The functions include receiving the digital artifact and one or more input images, and receiving a user query, from a user interface screen of an application being executed on a user client device, to create a design that includes the digital artifact and the one or more input images. The functions also include constructing a prompt, via a prompt construction engine, for transmission to a generative artificial intelligence (AI) tool, the prompt requesting the generative AI tool to identify a plurality of colors based on the user query and transmitting the prompt to the generative AI tool. The plurality of colors is received from the generative AI tool, and the plurality of colors is transmitted to a base palette generation engine, the base palette generation engine generating a base color palette based on at least one of one or more colors of the one or more input images and the plurality of colors received from the generative AI tool. The digital artifact is then recolored based on the base color palette.

In yet another general aspect, the instant disclosure presents a method for automatically recoloring a digital artifact to generate an aesthetically pleasing design. In some implementations, the method includes receiving the digital artifact and one or more input images, and receiving a user query, from a user interface screen of an application being executed on a user client device, the user query indicating a desire to generate the design, the design including the digital artifact and the one or more input images. The method also includes constructing a prompt, via a prompt construction engine, for transmission to a generative artificial intelligence (AI) tool, the prompt requesting the generative AI tool to identify an intended design style based on the user query. The method further includes transmitting the prompt to the generative AI tool, receiving from the generative AI tool the intended design style, transmitting the intended design style to a style to palette mapping engine to identify a plurality of colors that correspond to the intended design style, and transmitting the plurality of colors to a base palette generation engine, the base palette generation engine generating a base color palette based on at least one of one or more colors of the one or more input images or the plurality of colors received from the style to palette mapping engine. The digital artifact is then recolored based on the base color palette.

In a further general aspect, the instant application describes a non-transitory computer readable medium on which are stored instructions that when executed cause a programmable device to perform functions of receiving a user request, from a user interface screen of an application being executed on a user client device, to create a design that incorporates one or more user selected images into a digital artifact, receiving the digital artifact and the one or more user selected images, and extracting a plurality of colors from each of one or more user selected images via a color map engine. The functions also include filtering the plurality of colors to remove neutral colors, generating a base color palette based on the filtered plurality of colors via a base palette generation engine, applying the base color palette to the digital artifact via a color application engine to recolor the digital artifact based on the base color palette, and creating the design based on the recolored digital artifact and the one or more user selected images. The summary and the cited one or more of the subset of the plurality of chat messages are provided for display to a user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of elements involved in recoloring an artifact based on an input image.

FIG. 3A-3E depict examples of elements involved in recoloring an artifact based on various parameters.

FIG. 4A illustrates an example of generating a color palette from an image.

FIG. 4B is an example diagram that depicts a warmness value as distributed across hue angles.

FIG. 4C is an example diagram that depicts a coolness value as distributed across hue angles.

FIG. 5A is a flow diagram depicting an exemplary method for recoloring an artifact based on one or more input parameters.

FIG. 5B is a flow diagram depicting an exemplary method for automatically recoloring a digital artifact to generate an aesthetically pleasing design.

FIG. 5C is a flow diagram depicting another exemplary method for automatically recoloring an artifact based on one or more input parameters.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

Design applications and/or other content creation applications are commonly used by users to create various types of documents that include images. In many such applications, the user can select a pre-made template or other artifact and customize the pre-made template by adding their own image(s) and other elements to create a final design. Such applications may be used by users to create presentations, marketing materials (e.g., advertising, fliers, etc.), invitations, and other digital designs. While templates or other pre-made artifacts provide flexibility and increase the efficiency with which a user can create a design, there are many limitations to currently available templates. For example, most applications have a limited number of templates in preset colors that may not match the user's desired color scheme or the color scheme if one or more images the user intends to insert into the template. As a result, the user would have to search for and locate templates that correspond with their desired color scheme, which is a time-consuming and challenging task. Furthermore, even if the user finds a template that corresponds with their desired color scheme, that template may not fit well with the user's desired design. This limits the capability of the current content creation applications to provide templates that meet user's needs. Furthermore, some users may not be aware of color schemes that correspond with specific styles or moods. The user may only be aware of a mood or style they are interested in and not know how to select a template that meets their desired mood. Again, this limits the applications' ability to provide useful templates for design creation. However, providing templates that correspond to numerous users' desired color schemes or input images is a resource intensive task. To provide a template in many different colors, computing systems would need to design and store numerous color schemes, resulting in extensive memory and processing usage. Thus, there exists a technical problem of lack of adequate mechanisms for efficiently and accurately providing templates or other artifacts in color schemes that match a user's needs.

To address these technical problems and more, in an example, this description provides technical solutions for adjusting colors of artifacts (e.g., graphics) based on a variety of inputs, such as a general color scheme of other media, an artificial intelligence (AI) model determined color theme, user inputs and the like. The process involves recoloring an artifact such as a template based on a color theme of a user selected input image(s) and/or an identified color theme using an AI model to recreate the artifact (e.g., presentation document, background slides, templates, graphics, etc.) using the color theme. In one implementations, this involves the use of a color map model to extract colors from one or more input images and use of a base palette generation engine to generate a base palette based on the extracted colors. The base palette is then used by a color application algorithm to adjust the colors of artifact such that it corresponds with the color theme of the input image(s). Alternatively and/or additionally, an AI model may be used to suggest colors which are then used to generate a base palette for use by a color application algorithm to adjust the colors of the artifact. In other implementations, colors of an artifact is adjusted based on one or more color themes requested by the user. Recoloring may also be done on the basis of a product's brand colors, a user's prompt and image mood, and/or based on a user's video file or GIF. In some implementations, a multimodal model is used to collectively understand a user prompt as well as an image context to generate a relevant contextual palette that achieves a coherent design. In this manner, the technical solution provides the technical advantage of efficiently and accurately recoloring artifacts based on a user's needs. The technical benefits also include improvement to current content creation application in providing more template options without the need for creating and storing more templates.

As will be understood by persons of skill in the art upon reading this disclosure, benefits and advantages provided by such implementations can include, but are not limited to, a technical solution to the technical problems of lack of mechanisms for adjusting the color scheme of templates and other artifacts based on a media or AI provided color theme. The technical solutions enable use of color extraction techniques and/or AI models to generate a color palette which can then be used to automatically recolor an artifact and generate an aesthetically pleasing and/or desired artifact. This not only reduces or eliminates the need for a user to search through hundreds of templates or other artifacts to locate one with a desired color scheme, but it also reduces the amount of computing and human resources needed to generate and store templates. The technical effects include at least (1) improving the efficiency and accuracy of providing templates for design purposes; (2) improving the efficiency and accuracy of computing resources required to store templates for various content generation applications; and (3) increasing the efficiency of generating aesthetically pleasing digital designs.

As used herein, the terms “artifact,” refers to any document that includes one or more pages of graphics including images, icons, digital drawings and the like. Artifacts may include templates and any other editable documents in which one or more images or text can be inserted and/or edited to generate a graphical design such as a marketing material, a slide in a presentation, invitation, flier and the like.

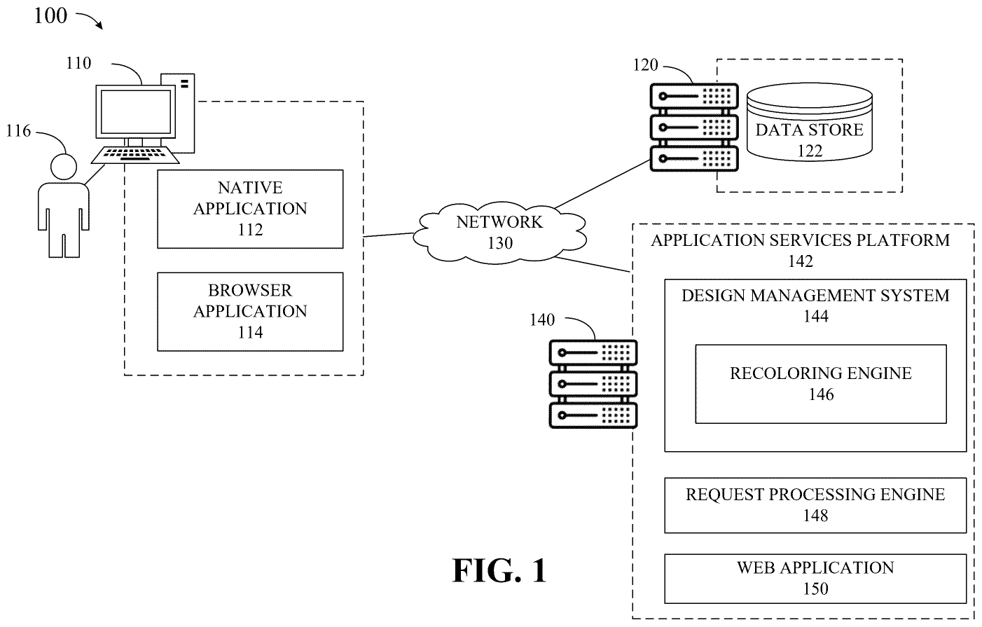

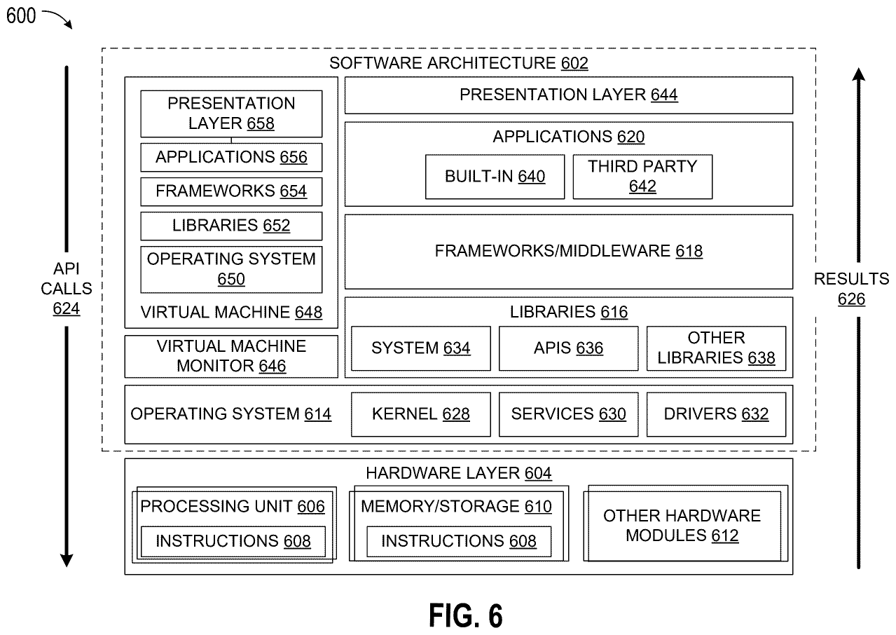

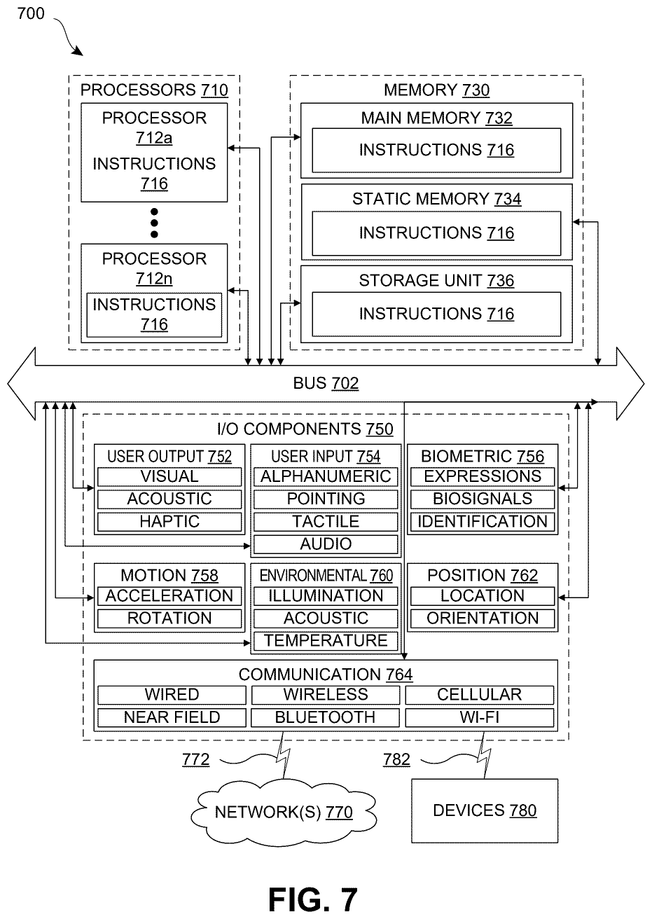

FIG. 1 illustrates an example system 100, upon which aspects of this disclosure may be implemented. The system 100 includes a client device 110, a data storage server 120 and a server 140 hosting an application services platform 142. While shown as one server, the servers 120 and 140 may represent a plurality of servers that provide data storage and/or various other services. The client device 110 may be a type of personal, business or handheld computing device having or being connected to input/output elements that enable a user to interact with various applications (e.g., native application 112 or browser application 114). The client device 110 may be utilized by a user 116 to utilize a content creation application (e.g., designer application, presentation application and the like) such as the application 112 or 114 to create a graphical document. Examples of suitable client devices 110 include but are not limited to personal computers, desktop computers, laptop computers, mobile telephones, smart phones, tablets, phablets, smart watches, wearable computers, gaming devices/computers, televisions; and the like. While one client device is displayed in FIG. 1, any number of client devices may be used in the system 100. The internal hardware structure of a client device is discussed in greater detail with respect to FIGS. 6 and 7.

The client device 110 includes a native application 112 and a browser application 114. The applications 112 and 114 are representative of one or more software programs executed on the client device that configure the device to be responsive to user input to allow a user create content. Examples of suitable applications include, but are not limited to a presentation application, design creation application, a copilot application and the like. The native application 114 is a web-enabled native application, in some implementations, that provides an interface for creating content. The browser application 114 can be used for accessing and viewing web-based content provided by the application services platform 142. In such implementations, the application services platform 142 implements one or more web applications, such as the web application 150, that enables users to communicate to create graphical content. The application services platform 142 supports both the native application 112 and the web application 150, and the users may choose which approach best suits their needs.

The client device 110 is connected to the server 120 via a network 130. The network 130 may be a wired or wireless network(s) or a combination of wired and wireless networks that connect one or more elements of the system 100. In some implementations, the network 130 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 130 is coupled to or includes portions of a telecommunications network for sending data in a variety of different communication protocols. In some implementations, the network 130 includes Bluetooth® communication networks or a cellular communications network for sending and receiving data including via short messaging service (SMS), multimedia messaging service (MMS), hypertext transfer protocol (HTTP), direct data connection, WAP, email, and the like.

The server 120 is connected to or includes the data store 122 which functions as a repository in which databases relating to artifacts (e.g., application templates), media, training data and the like may be stored. As such, the data store 122 may function as a cloud storage site for content creation, artifacts and documents. Although shown as a single data store, the data store 122 may be representative of multiple storage devices and data stores which are accessible by the client device 110 and/or application services platform 142. For example, the data store 122 may include a data store for storing artifacts and a different data store for storing training datasets for training one or more models used by the system 100.

The application services platform 142 includes a request processing unit 148, design management system 144 and the web application 150. The request processing unit 148 is configured to receive requests from an application implemented by the native application 112 of the client device 110 and/or the web application 150 of the application services platform 142 and transmit the request to an appropriate element of the application services platform 142 such as the design management system 144. For example, a request to insert an image into a template may be received via the native application 112 of the client device 110 and routed by the request processing unit 148 to the recoloring engine 146 to recolor the template before the image insert to ensure an aesthetically pleasing design.

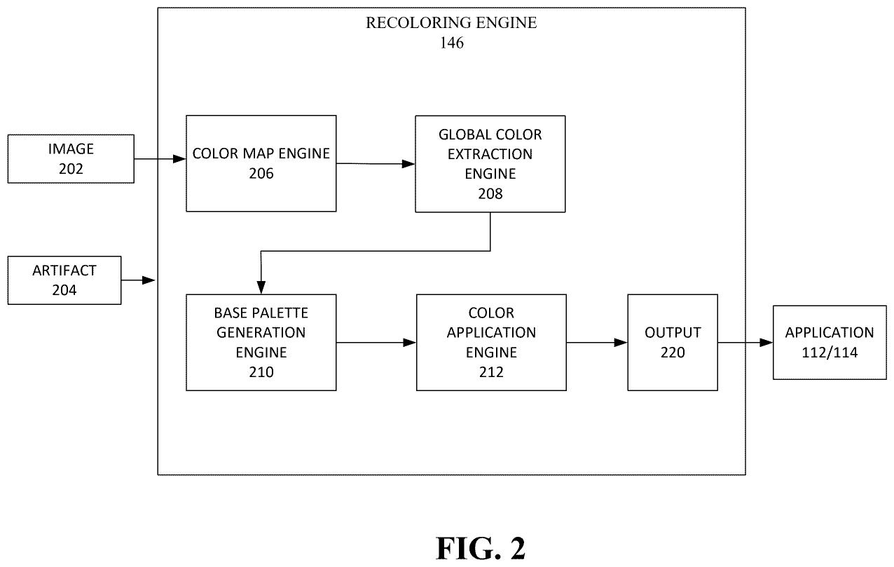

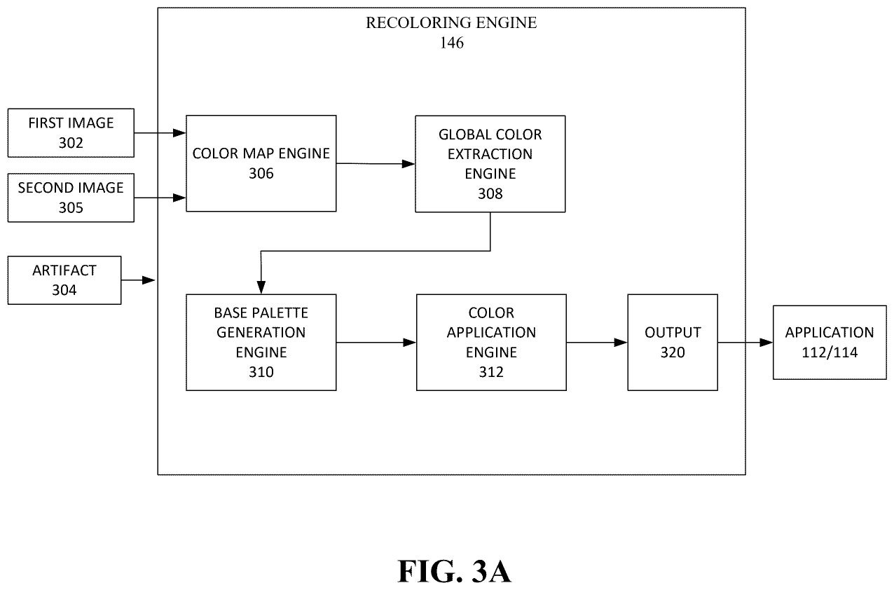

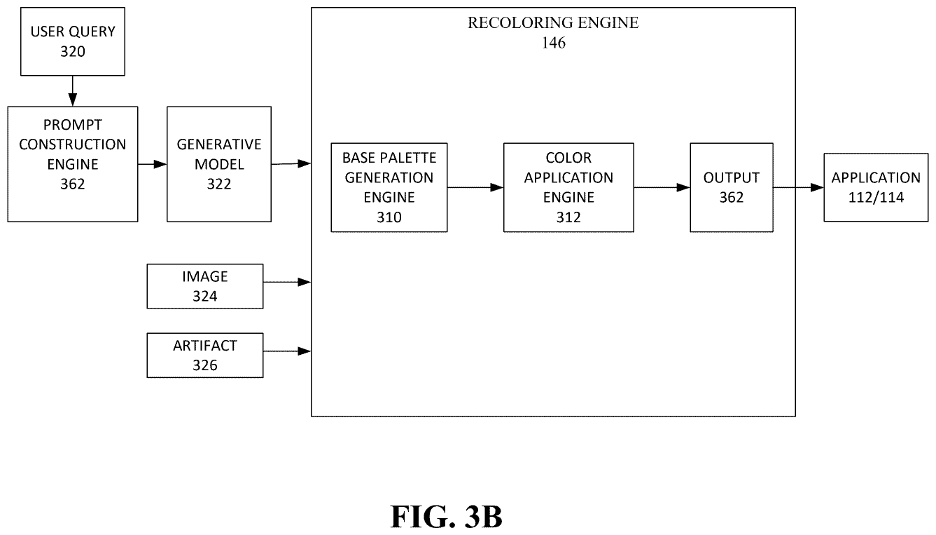

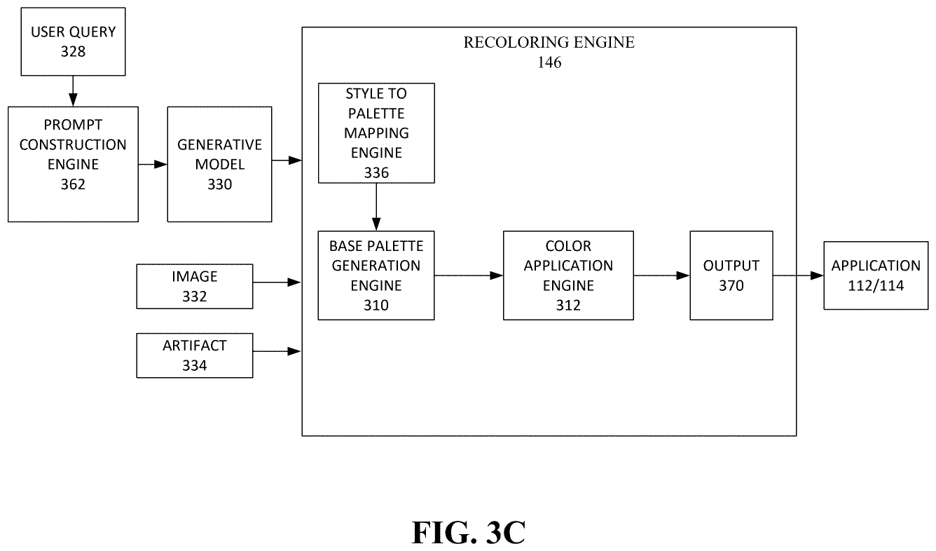

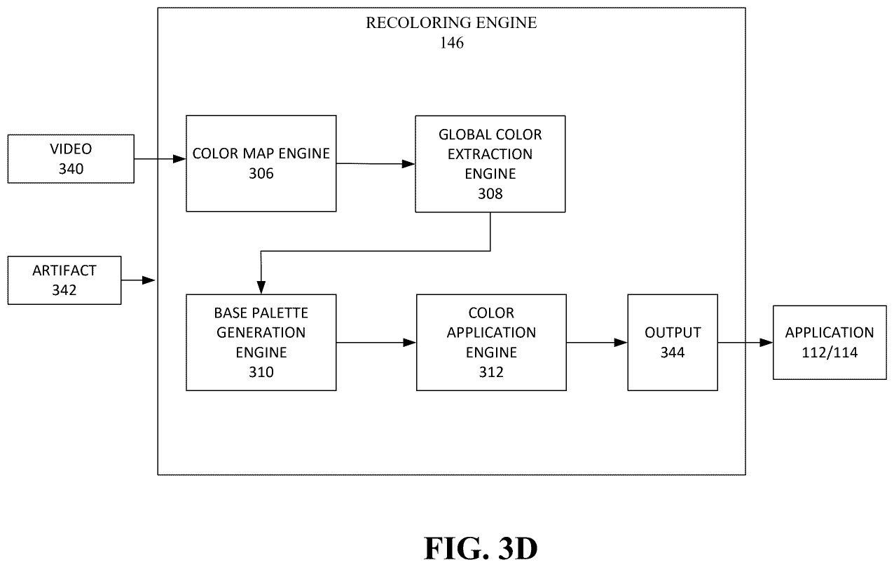

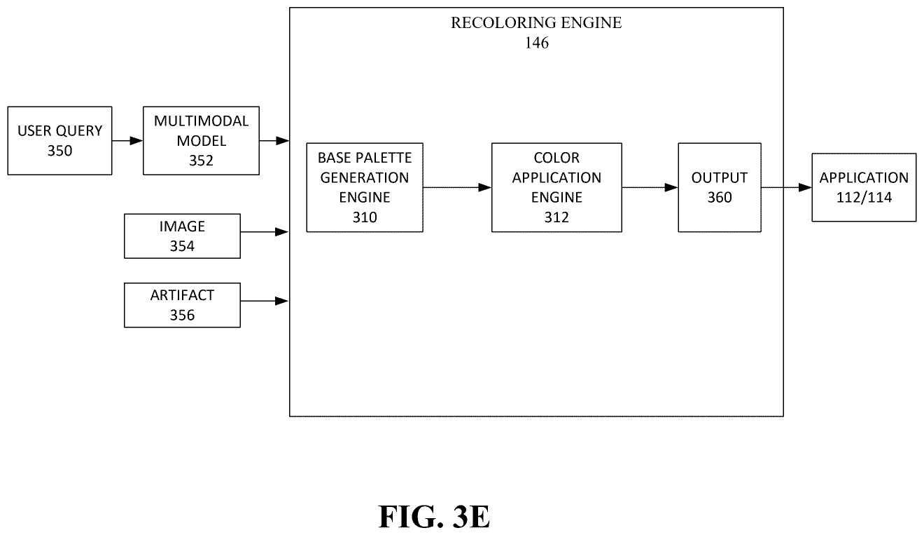

The design management system 144 includes a recoloring engine 146. The recoloring engine 146 is a pipeline that provides various elements for recoloring an artifact based on various parameters such as an input image. The internal structure and various elements of the recoloring engine 146 are discussed in greater detail with respect to FIG. 2 and FIGS. 3A-3D. Other implementations may include additional elements and/or a different combination of elements to provide services to the various components of the application services platform 142.

FIG. 2 depicts an example of elements involved in recoloring an artifact based on an input image. In some implementations, a user selects an image 202 to incorporate into an artifact 204. The image may be provided by the user (e.g., uploaded by the user or selected from a storage medium on the user's device) or may be selected by the user from among images provided by an application or service. The artifact 204 may be a template or another editable design document into which the image 202 may be inserted. The artifact 204 may be submitted by the user or it may be provided as an option by the application and selected by the user. In an example, the user submits the image 202 or a search query and the application presents one or more templates for selection by the user. The image 202 and the template 204 are transmitted by the client device to an application services platform over a network and then transmitted to the recoloring engine 146 for processing.

The recoloring engine 146 transmits the image 202 to the color map engine 206 to identify the colors present in the image 202. The color map engine 206 creates a color-based segmentation of the image 202 to get a near-true concise information on the colors present in the image with their location. The color map engine 206 may be an AI model designed to receive an image as an input and identify the dominant colors in the image to generate a color map for the image as an output. In an example, the color map engine 206 is a color-based image segmentation model. In some implementations, the image 202 is first downsampled (e.g., downsample the image 100%) to improve latency before the color map engine 206 extracts the colors. The extracted colors are used by the color map engine 206 to generate a color representation for the image. The color representation is a color map that displays the colors in the image along with their associated distribution. In an example, the distribution represents the percentage of each color in the image and is represented by a visual cue.

The color map is transmitted from the color map engine 206 to the global color extraction engine 208, which processes the color map to obtain a global color frequency list of image colors. Processing the color map includes removing neutral colors having gray and black undertones as these colors do not add significant information during color palette creation and may be misleading. In an example, this is achieved by first eliminating gray colors. For example, the colors are sorted by chroma and colors with a chroma value smaller than a given parameter (e.g., 0.024 with a maximum chroma value of 0.37) are eliminated. After the gray colors are eliminated, black colors are eliminated from the remaining colors by sorting the colors by lightness and eliminating colors with a lightness that is smaller than a given parameter (e.g., lightness smaller than 12 for any chroma and due). In this manner, the global color extraction engine 208 extracts colors global colors for the image that are likely to be useful in creating a color palette.

The filtered extracted colors are transmitted from the global color extraction engine 208 to the base palette generation engine 210, which selects and/or modifies the filtered and extracted image colors to create an esthetically pleasing color palette which provides color harmony. In some implementations, the base palette generation engine 210 utilizes the OKLCH color space to provide intelligent selection of colors with independent control on hue, chroma and lightness. That is because the number of colors in an image can vary significantly between a monochromatic image and a colorful image, and the RGB color space is not perceptually uniform. The OKLCH color space provides better performance over the RGB and other conventional color spaces.

In some implementations, the base palette generation engine 210 applies domain researched heuristics to select and modify the image colors. In an example, this includes sorting the colors based on their distribution (e.g., in descending distribution) and dividing the colors into different categories (e.g., buckets) based on the distribution (e.g., colors with 0-10 percent occupancy in a 10-percentage bucket, colors with 10-40 percent occupancy in a 30 percentage bucket and colors with 40-100 percent occupancy in a 60 percentage bucket). In some implementations, base palette generation involves selecting a predetermined number of colors for the color palette (e.g., 7 colors).

In some implementations, the following rules are used to select a base color for the color palette, where L is used to denote lightness, C is used to denote chroma and H is used to denote hue.

If there are one or more colors in the 60-percentile bucket,

```
Base_Color L = Weighted Mean by occupancy percentage of L from
all colors in 60 percentile.
Occupancy score normalized to total 1.0 for all colors; for example, the
  formula for two colors is ((0.41xL1 + 0.59xL2)/2)
If BaseColor_L < MinL
  BaseColor_L = MinL;
If occupancy of Base Color in Global Palette > 50%
  If BaseColor_L > 55
    BaseColor_L = BaseColor_L − DeltaL;
  Else BaseColor_L = BaseColor_L + DeltaL;
Base_Color C = Weighted Mean by occupancy percentage of chroma
  from all colors in 60 percentile.
Occupancy score normalized to total 1.0 for all colors; for example, the
  formula for two colors is ((0.41xC1 + 0.59xC2)/2)
Base_Color H = Select the hue value of color with highest occupancy.
```

Add the remaining colors in 60 percentile bucket to 30 percentile bucket.

To generate a color palette, in addition to selecting a base color, the base palette generation engine 210 also determines a color separation for the colors in the color palette. In an example, this is achieved using the following heuristics.

Determine the range of hue angle separation between colors in global palette by:
Sort all colors from 0 to 360.
Create 6 lists A to F.
According to hue angle, put each color into corresponding lists.
Calculate number of lists which are not empty
   ColorBrackets=number of lists that are not empty.
      Change default set of constants:

```
If ColorBrackets = 1 //monotone, dominantly single color
  Name the set as ConstantsStyle_Monotone
  Set the constants as,
      DeltaL = 6
      DeltaC = 0.024
      DeltaH = 10⁰
      MultH = 2
      MaxL = 94
      MinL = 24
If [(ColorBrackets ≥ 4) OR (list separation ≥ 3)] //vibrantly colorful
images
Name the set as ConstantsStyle_Vibrant
  Set the constants as,
    DeltaL = 6
    DeltaC = 0.024
    DeltaH = 15⁰
    MultH = 6
    MaxL = 94
    MinL = 24
```

Examples of list separation that equal 3, looking at lists that are not empty are the following:
A, D
A, B, D
B, E
C, E, F

In some implementations, the base palette generation engine 210 also creates a list of color highlights for the color palette. This may be achieved using a set of rules that may differ from one application to another application. In an example, the following algorithm is applied to create the highlights list.
Add spillover colors from 60% bucket to 30% bucket, that were not used for calculating the base color.
Select all colors from 30 percentile and 10 percentile bucket only.

```
  if (Base_Color_H > 115)&&(Base_Color_H < 330)
      Eliminate Base_Color_H to 330
  Else Eliminate 115 to 330
  For each color calculate warmness_score
        Peak Warm = 30
        warmness_score determined based on hue angle
// If an H value is closer to Peak Warm, its' warmness_score is maximum (0.5).
// If an H value is closer to range edges 330 and 115, the warmness_score is minimum (0).
// warmness_score is proportionately reduced the more it moves away from Peak Warm; note that
it is not a linear scale since to the left and right of Peak Warm it is different ranges.
// The warmness_score of color at 330 = warmness_score of color at 115 = 0.
// If an H value is between > 115 and < 330, the warmness_score is minimum constant value (0).
      Calculate highlight_sort_score for each color
      WarmCoolYMin = 0; WarmCoolYMax = 0.5; CoolWarmWeight = 1; OccupWeight =
      1.67; ChromaWeight = 2.33; OccupScoreMaxClamp = 0.3;
      Set priority_score = 0; for all colors from ColorMaps;
      highlight_sort_score = warmness_score + occpuancy_score + color_chroma +
      priority_score
      Sort colors by highlight_sort_score in decreasing order.
    Add colors in this order to the Hlts_list.
      The first color in the list is with highest highlight_sort_score
```

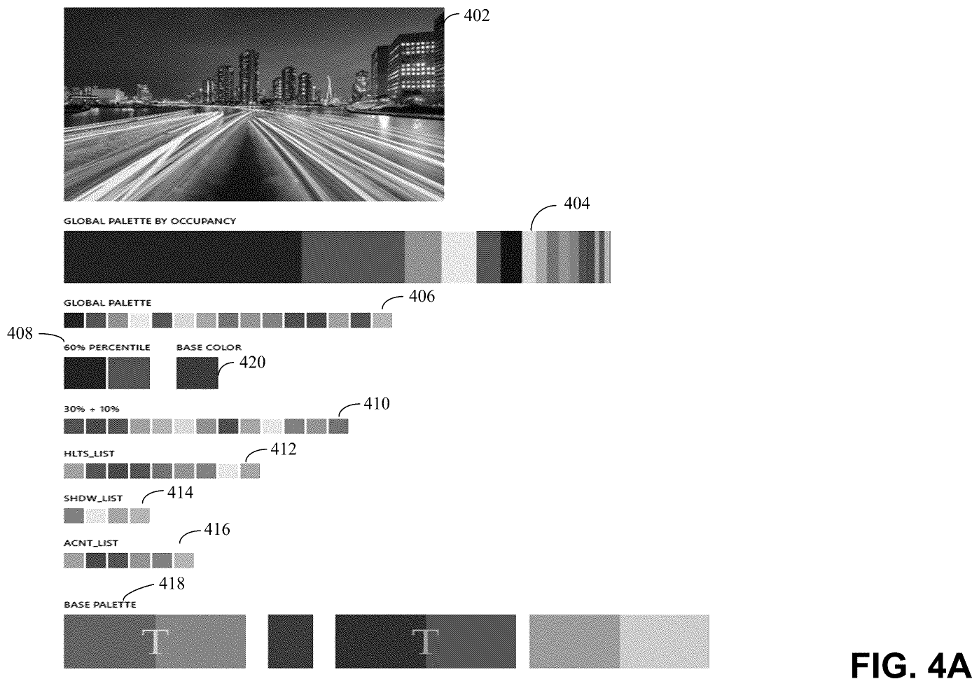

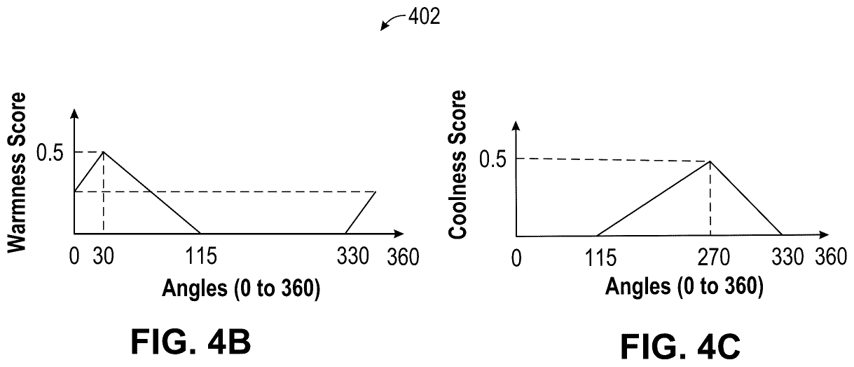

FIG. 4B is an example diagram that depicts a warmness value as distributed across hue angles. As illustrated the warmness value (e.g., warmness score) changes across the hue angle of zero to 360 degrees. The warmness score increases as the hue angle increases from zero to 30 degrees and then the warmness score decreases as the hue angle increases from 30 degrees to 115 degrees. The warmness score is zero from 115 degrees to 330 degrees and then it increases from the hue angle of 330 degrees to 360 degrees.

Colors of the color palette are then selected based on the highlights list, and/or their lightness, chroma and hue values. In an example, color 1 which is a soft highlight color is selected as follows:
If there are no colors in Hlts_list, follow below to create Color 1.

```
  L1 = if (Base_Color_L ≥ (MaxL − 2xDeltaL)
        L1 = Base_Color_L − 2xDeltaL;
      Else if (Base_Color_L > 6xDeltaL);
        L1 = (Base_Color_L + DeltaL)
      Else L1 = (Base_Color_L) + 2xDeltaL;
  C1 = (Base_Color_C + 2xDeltaC);
      If C1 < 3xDeltaC, C1 = 3xDeltaC
  H1 = (Base_Color_H − 2xDeltaH) % 360⁰ (modulus operator %)
Else
  Select the first color in Hlts_list
  Condition#1: Check if the hue angle separation to Base_Color_H is ≥ (2xDeltaH)
      abs(Base_Color_H − H1) ≥ (2xDeltaH)
      OR abs(Base_Color_H − H1) ≤ (360 − 2xDeltaH)
  Condition#2: Check if the hue angle separation to Base_Color_H is ≤ (2 x MultH x
  DeltaH)
      abs(Base_Color_H − H1) ≤ (2 x MultH x DeltaH)
    OR abs(Base_Color_H − H1) ≥ (360 − 2 x MultH x DeltaH)
  If both are True, select the color as Color1_Temp. If False, select the next color in
  Hlts_list and run the two conditions again. Repeat until both conditions are true.
  If no color matches the two conditions, create Color1_Temp as per no color in Hlts_list
  as given above (‘If there are no colors in Hlts_list...’).
  L1 = if [(Color1_Temp_L ≥ (MaxL − 2xDeltaL) OR (Base_Color_L ≥ (MaxL −
  2xDeltaL)]
        L1 = ([Greater of (Color1_Temp_L) and (Base_Color_L)] − 2xDeltaL);
      Else if ((Color1_Temp_L OR Base_Color_L) > 6xDeltaL);
        L1 = Greater of (Color1_Temp_L) and (Base_Color_L + DeltaL)
      Else L1 = Greater of (Color1_Temp_L) and (Base_Color_L + 2xDeltaL)
  C1 = Greater of (Color1_Temp_C) and (Base_Color_C + 2xDeltaC)
      If C1 < 3xDeltaC, C1 = 3xDeltaC
  H1 = Color1_Temp_H
```

In an example, the second color in the color palette which may be a sharp highlight color is identified using the following algorithm:
If there are no colors remaining in Hlts_list, follow below to create Color 2:

```
  L2 = if (L1 ≥ (MaxL − 2xDeltaL)
      L2 = L1 + DeltaL;
    Else L2 = L1 + 2xDeltaL
    MaxL and MinL thresholds apply, to keep L2 in range.
  C2 = (C1 − DeltaC); C of Color1 minus DeltaC
  H2 = (H1 + DeltaH) % 360° ;(modulus operator %)
Else
  Select the next color in Hlts_list after H1
  Condition#1: Check if the hue angle separation to Base_Color His ≥ DeltaH
    abs(Base_Color_H − H1) ≥ DeltaH
    OR abs(Base_Color_H − H1) ≤ (360 − DeltaH)
  Condition#2: Check if the hue angle separation to Base_Color_His ≤ (MultH x DeltaH)
    abs(Base_Color_H − H1) ≤ (MultH x DeltaH)
    OR abs(Base_Color_H − H1) ≥ (360− (MultH x DeltaH))
  Condition#3: Check if the hue angle separation to H1 is ≥ DeltaH
    abs(H1 − H2) ≥ DeltaH
    OR abs(H1 − H2) ≤ (360−DeltaH)
  If all are True, select the color as Color2_Temp. If False, select the next color in
  Hlts_list and run the two conditions again. Repeat until both conditions are true.
    If no color matches the two conditions, we create Color2_Temp based on rules
    for ‘If there are no colors remaining in Hlts_list...’ given above.
  L2 = if (L1 ≥ (MaxL − 2xDeltaL)
      L2 = L1 + DeltaL;
    Else L2 = L1 + 2xDeltaL
    MaxL and MinL thresholds apply, to keep L2 in range.
  C2 = (C1 − DeltaC); C of Color1 minus DeltaC
  H2 = Color2_Temp_H
```

In some implementations, the third color in the color palette is the base color which was discussed above. In another example, shadow colors for the color palette are identified using the following algorithm:
Add spillover colors from 60% bucket to 30% bucket, that were not used for calculating Base Color.
Select all colors from 30 percentile and 10 percentile bucket only.
Eliminate colors in circular ranges ([min[H1, H2, H3]−4×DeltaH) to (max[H1, H2, H3]);
Min/Max calculated on a clockwise direction, starting from 330 to 0, 0 to 330. If (abs(H3−max[H1, H2])>4×DeltaH)
Min/Max calculated on a clockwise direction, starting from 330 to 0, 0 to 330.
Add colors back to the list in the range (max[H1, H2]+4×DeltaH) to H3.
   For each color calculate coolness_score

```
  PeakCool = 270
  coolness_score is determined based on hue angle
        // If an H value is closer to PeakCool, it's coolness_score is maximum (0.5).
        // If an H value is closer to range edges 330 and 115, the coolness_score is minimum
        (0).
      // coolness_score proportionately reduces the more it moves away from PeakCool;
      note that it is not a linear scale since to the left and right of PeakCool it is different
      ranges.
    // The coolness_score of color at 330 = coolness_score of color at 115 = 0.
// If an H value is between > 330 and < 115, the coolness_score is minimum constant value (0).
Calculate shdw_sort_score for each color
  WarmCoolYMin = 0; WarmCoolYMax = 0.5; CoolWarmWeight = 1; OccupWeight =
  1.67; ChromaWeight = 2.33; OccupScoreMaxClamp = 0.3;
  Set priority_score = 0; for all colors from ColorMaps;
  shdw_sort_score = coolness_score + occpuancy_score + color_chroma + priority_score
Sort colors by shdw_sort_score in decreasing order.
Add colors in this order to Shdw_list
  The first color in the list is with highest shdw_sort_score.
```

FIG. 4C is an example diagram that depicts a coolness value as distributed across hue angles. As illustrated the coolness value (e.g., coolness score) changes across the hue angle of zero to 360 degrees. The coolness score increases as the hue angle increases from 115 to 270 degrees and then the coolness score decreases as the hue angle increases from 270 degrees to 330 degrees.

The fourth color in the color palette may also be selected based on heuristics. In an example color 4 is selected using the following algorithm.
If there are no colors remaining in Shdw_list, create Color 4 using the following algorithm.

```
  L4 = L5 − DeltaL
    MaxL and MinL thresholds apply, to keep L4 in range.
    if (abs(L1−L4) < DeltaL)
      if (L1 > (MinL + 2xDeltaL))
        L4 = L1 − (1.5xDeltaL);
      Else L4 = L1 + 2xDeltaL;
  C4 = C5 − DeltaC; chroma of Color5 minus DeltaC
  H4 = (H5 − 2xDeltaH⁰) % 360⁰; (modulus operator %)
Else
  Select the next color in Shdw_list.
  Condition#1: Check if the hue angle separation to Hlts_HMax is ≥
  DeltaH
    abs(Hlts_HMax − H4) ≥ DeltaH
    OR abs(Hlts_HMax − H4) ≤ (360−DeltaH)
  Condition#2: Check if the hue angle separation to Hlts_HMax is ≤
  (MultH x DeltaH)
    abs(Hlts_HMax − H4) ≤ (MultH x DeltaH)
    OR abs(Hlts_HMax − H4) ≥ (360 − (MultH x DeltaH))
  Condition#3: Check if the hue angle separation to H5 is ≥ 2xDeltaH
    abs(H5 − H4) ≥ 2xDeltaH OR abs(H5 − H4) ≤ (360−2xDeltaH)
```

If all are True, select the color as Color4_Temp. If False, select the next color in
Shdw_list and run the two conditions again. Repeat until both conditions are true.
   If no color matches the two conditions, create Color4_Temp based on rules for ‘If there are no colors remaining in Shdw_list . . . ’ given above.

```
L4 = L5 − DeltaL
  MaxL and MinL thresholds apply, to keep L4 in range.
  if (abs(L1−L4) < DeltaL)
    if (L1 > (MinL + 2xDeltaL))
      L4 = L1 − (1.5xDeltaL);
    Else L4 = L1 + 2xDeltaL;
C4 = C5 − DeltaC; chroma of Color5 minus DeltaC
H4 = Color4_Temp_H
L5 = if [(Color5_Temp_L ≥ (MaxL − 2xDeltaL) OR (Base_Color_L ≥ (MaxL −
2xDeltaL)]
    L5 = ([Greater of (Color5_Temp_L) and (Base_Color_L)] − 2xDeltaL);
  Else if ((Color5_Temp_L OR Base_Color_L) ≥ 6xDeltaL)
    L5 = Greater of (Color5_Temp_L) and (Base_Color_L + 2xDeltaL)
  Else L5 = Greater of (Color5_Temp_L) and (Base_Color_L + 4xDeltaL)
  MaxL and MinL thresholds apply, to keep L5 in range.
  if (abs(L2−L5) < DeltaL)
    if (L2 > (MinL + 2xDeltaL))
      L5 = L2−DeltaL;
    Else L5 = L2 + 2xDeltaL;
C5 = Greater of (Color5_Temp_C) and (Base_Color_C + 2xDeltaC);
  If C5 < 3xDeltaC, C5 = 3xDeltaC
H5 = Color5_Temp_H
```

In some implementations the fifth color is identified before the fourth color. To identify the fifth color, another set of heuristics may be applied. In an example, color 5 is identified using the following algorithm.
Set max (H1, H2, H3) as Hlts_Hmax (on a clockwise direction, starting from 330 to 0, 0 to 330;
If there are no colors in Shdw_list, follow below to create Color 4.

```
  L5 = if (Base_Color_L ≥ (MaxL − 2xDeltaL)
      L5 = Base_Color_L − 2xDeltaL;
    Else if (Base_Color L ≥ 4xDeltaL)
      L5 = (Base_Color_L+ 2xDeltaL)
    Else L5 = (Base_Color_L) + 4xDeltaL
    MaxL and MinL thresholds apply, to keep L5 in range.
    if (abs(L2−L5) < DeltaL) //to ensure L separation as per order in
    appl. rule
      if (L2 > (MinL + 2xDeltaL))
        L5 = L2−DeltaL;
      Else L5 = L2 + 2xDeltaL;
  C5 = (Base_Color_C − DeltaC);
    If C5 < 3xDeltaC, C5 = 3xDeltaC
  H5 = (Hlts_HMax + (3xDeltaH) % 360⁰ ;(modulus operator %)
Else
  Select the first color in Shdw_list
  Condition#1: Check if the hue angle separation to Hlts_HMax is ≥
  (3xDeltaH)
    abs(Hlts_Hmax − H5) ≥ (3xDeltaH)
    OR abs(Hlts_Hmax − H5) ≤ (360 − 3xDeltaH)
  Condition#2: Check if the hue angle separation to Hlts_HMax is ≤
  (2 x MultH x DeltaH)
    abs(Hlts_HMax − H5) ≤ (2 x MultH x DeltaH)
    OR abs(Hlts_HMax − H5) ≥ (360 − (2 x MultH x DeltaH))
```

If both are True, select the color as Color5_Temp. If False, select the next color in Shdw_list and run the two conditions again. Repeat until both conditions are true.
If no color matches the two conditions, create Color5_Temp as per no color in Shdw_list as given above (‘If there are no colors in Show_list . . . ’).

The next color in the color palette is the sixth color, which may be an accent color and can be identified in a similar manner. In an example, color 6 is selected using the following algorithm.
Select Hlts_list, eliminate all colors from 30% bucket and retain only colors from 10% bucket to generate the Acnt_list.
If there are no colors in Acnt_list, follow below to create Color 6.

```
  L6 = 100 − ((L4+L5)/2); complimentary of mean of Color4_L & Color5_L
    If (L6 ~ L5) < 6xDeltaL ; ~ is difference
        Then L6 = L5 + 2xDeltaL; up to MaxL
    If L6 < 2xMinL, increase to L6 = 4xDeltaL
    MaxL and MinL thresholds apply, to keep L6 in range.
  C6 = 0.24 − ((C4+C5)/2); complimentary of mean of Color4_C & Color5_C
  H6 = if (H5 ≤(115 − (2xDeltaH))); //to ensure accent is closer to warmer spectrum
          H6 = (H5 + (2xDeltaH)) % 360⁰ ;(modulus operator %)
    Else H6 = (H4 − (2 x DeltaH)) % 360⁰
Else
  L6 = 100 − ((L4+L5)/2); complimentary, with min threshold at 18.
    If (L6 ~ L5) < 6xDeltaL; ~ is difference
        Then L6 = L5 + 2xDeltaL; up to MaxL
    If L6 ≤ 2xMinL, increase to L6 = 4xDeltaL
  C6 = 0.24 − ((C4+C5)/2) complimentary of Color4_C & Color5_C
  Select the first color in Acnt_list
  Condition#1: Check if the hue angle separation to H4 ≥ (MultH x DeltaH)
    abs(H4 − H6) ≥ (MultH x DeltaH) OR abs(H4 − H6) ≤ (360 − (MultH x DeltaH))
  Condition#2: Check if the hue angle separation to H4 is ≤ (2 xMultH x DeltaH)
    abs(H4 − H6) ≤ (2 xMultH x DeltaH) OR abs(H4−H6) ≥ (360 − (2 xMultH x
    DeltaH))
  If both are True, select the color as Color6_Temp. If False, select the next color in
  Acnt_list and run the condition again. Repeat until true.
  If no color matches the condition
    If (H5 ≤ (115 − (2xDeltaH))); to ensure accent is closer to warmer spectrum
      Color6_Temp_H = (H5 + (2xDeltaH)) % 360⁰ ;(modulus operator %)
    Else Color6_Temp_H = (H4 − (2xDeltaH)) % 360⁰
  H6 = Color6_Temp_H
```

Next, the seventh color in the color palette is selected. In some implementations, this color is an accent highlight color. Similar to the previous colors in the color palette, this color may be identified using pre-determined rules. In an example, the color is identified using the following algorithm.
Select Shdw_list, eliminate all colors from 30% bucket and retain only colors from 10% bucket.
Use this list for Color7 calculation.
If there are no colors remaining in Acnt_list, follow below to create Color7

```
  L7 = 100 − ((L1+L2)/2; complimentary of Color1_L & Color2_L
    If (L7 ~ L2) < 6xDeltaL ; ~ is difference
        Then L7 = L2 + 2xDeltaL
    If L7 < 2xMinL, increase to L7 = 4xDeltaL
    MaxL and MinL thresholds apply, to keep L7 in range.
  C7 = 0.24 − ((C1+C2)/2; complimentary of Color1_C & Color2_C
  H7 = if (H2 ≤ (330 − (2xDeltaH))) ; to ensure accent is closer to cool spectrum
        H7 = (H2 + (2xDeltaH)) % 360⁰ ;(modulus operator %)
    Else H7 = (H1 − (2xDeltaH)) % 360⁰
Else
  L7 = 100 − ((L+L2)/2); complimentary; min threshold at 24 and mx at 96.
    If (L7 ~ L2) < 6xDeltaL ; ~ is difference
        Then L7 = L2 + 2xDeltaL
    If L7 < 2xMinL, increase to L7 = 4xDeltaL
    MaxL and MinL thresholds apply, to keep L7 in range.
  C7 = 0.24 − ((C1+C2)/2); complimentary; clipping highest chroma at 0.24 to calculate
  complimentary, even though theoretical max is 0.37
  Select the first color in Acnt_list
  Condition#1: Check if the hue angle separation to H2 ≥ (MultH x DeltaH)
    abs(H2 − H7) ≥ (MultH x DeltaH) OR abs(H2 − H7) ≤ (360 − (MultH x DeltaH))
  Condition#2: Check if the hue angle separation to H2 is ≤ (2 x MultH x DeltaH)
    abs(H2 − H7) ≤ (2 x MultH x DeltaH) OR abs(H2 − H7) ≥ (360 − (2 x MultH x
    DeltaH))
  If True, select the color as Color7_Temp. If False, select the next color in Acnt_list and
  run the condition again. Repeat until true.
  If no color matches the condition,
    if (H2 ≤ (330 − (2xDeltaH))); to ensure accent is closer to cool spectrum
      Color7_Temp_H = (H2 + (2xDeltaH)) % 360⁰
    Else Color7_Temp_H = (H1 − (2xDeltaH)) % 360⁰
  H7 = Color7_Temp_H
```

It should be noted that the above algorithms are merely examples. In different implementations, different sets of rules and algorithms may be applied by the base palette generation engine 210 to generate the color palette. In some implementations, artificial intelligence may be used to identify the color palette.

FIG. 4 illustrates an example of generating a color palette from an image. Image 402 represents an image from which a color palette is being generated. The image may be received from a user. After image 402 is processed via a color map engine, the global palette by occupancy color map 404 is generated. As depicted, color map 404 displays the dominant colors in image 402 by representing the percentage of their occupancy in the image. From the global palette by occupancy color map 404, a global palette 406 may be generated which simply displays the colors in the color map. The global palette 406 does not include neutral colors such as gray or black colors. Based on the global palette 406 and the global palette by occupancy color map 404, different color buckets are then generated. These include 60% percentile bucket 408, and 30% percentile+10% percentile bucket 410. In some examples, the 30% percentile bucket is different from the 10% percentile bucket.

The base palette generation system 210 utilizes the global palette 406 and the different color buckets to generate the base color 420, highlights list 412, shadow list 414 and the accent color list 416. Based on these colors, the base palette 418 is then generated. As depicted, the base palette 418 (i.e., color palette for the image) includes 7 colors.

Referring back to FIG. 2, in some implementations, to ensure there is enough visual variation among the generated color palette results with a single image, the base palette generation engine 210 introduces variation into the base palette order while retaining the same set of application rules.
The color order in the color palette by default can be denoted as:
Color1 (L1, C1, H1); Color2 (L2, C2, H2); Color3 (L3, C3, H3); Color4 (L4, C4, H4); Color5 (L5, C5, H5); Color6 (L6, C6, H6); Color7 (L7, C7, H7).

Variation is introduced in these colors by rotating colors. Color may be rotated by retaining the same L and C values from the default color palette color order, while rotating the H value as discussed below to generate variations of the palette. By rotating only hues and not lightness and chroma, the final composition will retain harmonious intensity variations between colors as defined by the default color order in the color palette. Hue may be rotated as follows: If base color is warm,
If (Color3_H≤1150) && (Color3_H≥3300);
Color1 (L1, C1, H1); Color2 (L2, C2, H2); Color3 (L3, C3, H3); Color4 (L4, C4, H4); Color5 (L5, C5, H5); Color6 (L6, C6, H6); Color7 (L7, C7, H7)
Color1 (L1, C1, H3); Color2 (L2, C2, H1); Color3 (L3, C3, H2); Color4 (L4, C4, H4); Color5 (L5, C5, H5); Color6 (L6, C6, H6); Color7 (L7, C7, H7)
Color1 (L1, C1, H2); Color2 (L2, C2, H3); Color3 (L3, C3, H1); Color4 (L4, C4, H4); Color5 (L5, C5, H5); Color6 (L6, C6, H6); Color7 (L7, C7, H7)
Color1 (L1, C1, H2); Color2 (L2, C2, H1); Color3 (L3, C3, H3); Color4 (L4, C4, H4); Color5 (L5, C5, H5); Color6 (L6, C6, H6); Color7 (L7, C7, H7)
If Base is cool,
If (Color3_H≤3300) && (Color3_H≥1150); Color1 (L1, C1, H1); Color2 (L2, C2, H2); Color3 (L3, C3, H3); Color4 (L4, C4, H4); Color5 (L5, C5, H5); Color6 (L6, C6, H6); Color7 (L7, C7, H7)
Color1 (L1, C1, H1); Color2 (L2, C2, H2); Color3 (L3, C3, H4); Color4 (L4, C4, H5); Color5 (L5, C5, H3); Color6 (L6, C6, H6); Color7 (L7, C7, H7)
Color1 (L1, C1, H1); Color2 (L2, C2, H2); Color3 (L3, C3, H5); Color4 (L4, C4, H3); Color5 (L5, C5, H4); Color6 (L6, C6, H6); Color7 (L7, C7, H7)
Color1 (L1, C1, H1); Color2 (L2, C2, H2); Color3 (L3, C3, H3); Color4 (L4, C4, H5); Color5 (L5, C5, H4); Color6 (L6, C6, H6); Color7 (L7, C7, H7).

Thus, if the base color is warm, hue value is rotated between the first three colors and if the base color is cool, hue value is rotated between colors 3, 4 and 5. This results in visual variation among the generated results to provide a variety of options.

Once the color palette is generated, it is transmitted to the color application engine 212, which applies the color palette to the artifact 204 according to a set of predetermined heuristics and other functions to recolor the artifact 204. An artifact such as the artifact 204 may include one or more shapes, text segments and/or images which may overlap. As a result, careful choice of colors for the different portions is important for the overall aesthetics of the design. For example, accent color when applied to a large shape may create an unbalanced look and negatively affect the overall design. However, if the artifact includes fewer or smaller shapes, application of the same accent color may improve the overall look. Thus, careful heuristics are required to cater to different cases. In many designs, text is one of the most important elements of the design and text legibility needs to be optimized while keeping the color balance intact as legibility and color balance often operate inversely. In some implementations, a constrained chroma and lightness interpolation technique is utilized by the color application engine 212 to ensure base palette colors are intelligently manipulated based on the text region background colors to ensure legibility while ensuring the text stands out. The lightness/luminosity of the color and chroma were modified very carefully after color selection to maintain the legibility of elements across layers.

In some implementations, the color application engine 212 first processes the artifact 204 to identify various elements of the artifact 204 before recoloring. In an example, first all elements of the artifact 204 having the same color are identified and considered as one. The manner in which the color application engine 212 recolors the artifact depends on a variety of parameters including the number, shape and relationship of the various elements of the artifact. For example, text color depends on the color of the elements the text overlaps with. For overlapping shapes and image sections, color variations also depend on the overlap and/or distance between the various elements. As a result, the color application engine 212 first identifies the various elements of the artifacts and determines their colors and their relationships with each other.

In some implementations, elements having the same color, but different opacity are also considered as one. Additionally, elements of the same kind are also identified and categorized as one type of element (e.g., all text segments, all rectangular shapes, all circular shapes, etc.). In some examples, the color application engine 212 retains the opacity or alpha value information for the elements and applies the same during application. The color application engine 212 also identifies the text elements with a foreground of white or black and retains the information for those elements during application of color. Text elements with white or black and a defined alpha/opacity may also be identified. At the time of color application, the choice between white or black will depend on the mean value of lightness (L) of the region of interest (ROI). In an example, colors with L≤12 are considered black, and colors with L≥99 are considered white.

Once the elements are identified, the color application engine 212 applies various rules to select the color for each element. The rules may be predetermined or may be changed from one application to another. In an example, for a single image, where the artifact does not include any shapes but includes text, the color application engine 212 applies color to a text segment that is over an image or overlaps with an image, based on the following algorithm.
Identify region of interest as follows:
Textbox boundary=Region of interest boundary
Calculate weighted mean (based on occupancy score) for L and C from colors that fall in region of interest boundary.
If the textbox boundary overlaps an image and other elements, include all overlapping elements in weighted mean calculation.
   Identify if white or black has been inherited for any text. If yes, follow below for each of those text segments.

```
If the ROI weighted mean L ≤ 85
  If ROI weighted mean L ≥ 55
    Foreground = Retain from original (whether black or white);
    retain alpha
  Else Foreground = White; oklch(100% 0 0); retain alpha
Else
  Foreground = Black; oklch(0% 0 0); Retain alpha from original
```

If there is no white or black inherited for any text, proceed individually only for those text segments that are not white or black.

```
Identify all colors in region of interest boundary
Sort by occupancy and select the hue angle of highest value color as RoI_H
If (RoI_H ≤ 115⁰) && (RoI_H ≥ 330⁰); //warm
  Heading foreground = Color1 (Soft Highlight Color)
    L = 100 − (Weighted_Mean_L)
      If (L ~ Weighted_Mean_L) < 6xDeltaL ; ~ is difference
        Then L = (Max[Weighted_Mean_L, 100 − Weighted_Mean_L]
        + 2xDeltaL); up to MaxL
      If L ≤ 2xMinL, increase to L = 4xDeltaL
    C = 0.24 − (weighted mean C)
    H = H of Color1
  Subheading foreground = Color7 (Accent Highlight Color)
    L = 100 − (Weighted_Mean_L)
      If (L ~ Weighted_Mean_L) < 6xDeltaL ; ~ is difference
        Then L = (Max[Weighted_Mean_L, 100 − Weighted_Mean_L]
        + 2xDeltaL); up to MaxL
      If L ≤ 2xMinL, increase to L = 4xDeltaL
    C = 0.24 − (Weighted_Mean_C)
    H = H of Color2
  Body foreground = Color7 (Accent Highlight Color)
    L = 100 − (Weighted_Mean_L)
      If (L ~ Weighted_Mean_L) < 6xDeltaL; ~ is difference
        Then L = (Max[Weighted_Mean_L, 100 − Weighted_Mean_L]
        + 2xDeltaL); up to MaxL
      If L ≤ 2xMinL, increase to L = 4xDeltaL
    C = 0.24 − (Weighted_Mean_C)
    H = H of Color2
For all text, retain its original opacity/alpha.
If (RoI_H ≤ 330⁰) && (RoI_H ≥ 115⁰); //cool
  Heading foreground = Color5 (Soft Shadow Color)
    H = H of Color6
  Subheading foreground = Color6 (Accent Shadow Color)
    H = H of Color2
  Body foreground = Color6 (Accent Shadow Color)
    H = H of Color4
```

For all text, retain its original opacity/alpha.

Once the hue is determined, the color application engine 212 performs lightness and chroma interpolation to apply color to text that is over an image or overlaps with an image. To achieve inversion in both chroma and lightness (with respect to region of interest background colors), the mean value of L, C is calculated and used to represent the region of interest colors. Once the relevant hue is selected (from previously discussed rules), it is modified to ensure that the text is legible (e.g., text pops out). However, since in the OKLCH color space, not all colors exist, this is challenging. This may be achieved by using the following algorithm.
1. The goal is to invert chroma (chroma brings depth). Since the max chroma varies with respect to hue, first we obtain maximum chroma at the selected hue.
2. Perform chroma inversion as follows:
   Divide the Chroma region into 4 parts.

$$Quart 1 = ( Ci > 0 \&\& Ci <= Ccusp / 4 ) ;$$

$$Quart 2 = ( Ci > Ccusp / 4 \&\& Ci <= Ccusp / 2 ) ;$$

$$Quart 3 = ( Ci > Ccusp / 2 \&\& Ci <= 3 * Ccusp / 4 ) ;$$

$$Quart 4 = ( Ci > 3 * Ccusp / 4 \&\& Ci <= Ccusp ) ;$$

Chroma is inverted so as to maintain at least Ccusp/4 difference between Ci(ROI) and Cnew(text)
   In an example, chroma is clamped at a minimum so that grayish/low chroma colors that do not look aesthetically pleasing are generated. However, even for the low chroma boundary, when color turns grey varies with respect to hue and the mechanism to ensure colors do not turn into gray may differ from case to case.

```
if(Quart1 ∥ Quart4 )
  Cnew = clamp(Ccusp − Ci, 0, 0.3* Ccusp);
else if( Quart2 )
  Cnew = Ci + Ccusp / 2;
else if( Quart3 )
  Cnew = clamp(Ci − Ccusp / 2, 0, 0.3* Ccusp);
```

Once chroma inversion has been achieved, the color application engine 212 tries to ensure that there is sufficient lightness contrast. However, if lightness is changed without taking other parameters into account, the system may end up in a region where color does not exist (e.g., grey area). To achieve the results and take various parameters into account, the color application engine 212 iteratively checks if at the calculated chroma, there exists the expected lightness margin. If not, chroma is iteratively decreased. It should be noted that maximum lightness difference is not always desirable. Lightness contrast is achieved, in one example, according to the following algorithm.

Min. Lightness difference targeted:

```
Heading text L
  UptoROI_L < 30
  36
  ROI_L < 50,
  +36 from ROI_L
  Else
  +24
  ROI > 75
  −36
Subheading/Body text L
  ROI > 75
    −36
  else
    +36
```

If Cmin (0.3 Ccusp), during the chroma inversion, this means there are greyish colors which do not look aesthetically pleasing. To avoid this, the text color is changed to either white or black (rather than dull grey) by using a white/black logic.

```
If L3 (L of Color3) ≤ 85
  Stroke/Fill = White; oklch(100% 0 0)
Else
  Stroke/Fill = Black; oklch(0% 0 0)
```

For the background color, in an example artifact which includes an image, text and a limited number of shapes defined by distinct colors, in an example, the color application engine 212 utilizes the following algorithm to determine the background color.

Check the number of distinct elements with different colors.
Count Background as 1; Count all Text as 1
Count all shapes with same color as 1;
   Same colors with different opacity/alpha is considered as 1; Exclude any shapes with either Black or White.
Set this count as FG_ColorCount.
Check color temperature (H3) of Color3 (Base Color)
If background is fully obscured by image or another shape, skip coloring background.

```
If(IsUserIntentColor = True))
  Background Color = Color3(Base Color)
Else if (H3 ≤ 115⁰) && (H3 ≥ 330⁰); //warm
  If ((FG_ColorCount ≤ 2)
    Background Color = Color2 (Sharp Highlight Color)
  Else If ((FG_ColorCount ≤ 3)&&(ContstantsStyle_Name ≠
  ‘ConstantsStyle_Monotone’)
    Background Color = Color1 (Soft Highlight Color)
  Else Background Color = Color3 (Base Color)
Else If (H3 ≤ 330⁰) && (H3 ≥ 115⁰); //cool
  If ((FG_ColorCount ≤ 2)
    Background Color = Color4 (Sharp Shadow Color)
  Else If ((FG_ColorCount ≤ 3)&&(ContstantsStyle_Name ≠
  ‘ConstantsStyle_Monotone’)
    Background Color = Color5 (Soft Shadow Color)
  Else
    Background Color = Color3 (Base Color)
```

Check if there is an overlay shape on top of an image. A mask shape is defined as any shape that covers significant visible area of an image (calculate as 33% overlap) with alpha <0.90.
Mask Fill=Apply same color as Background, retain the original alpha.

For shape colors, in an example artifact which includes an image, text and a limited number of shapes, in an example, the color application engine 212 utilizes the following algorithm to determine the shape fill color and/or shape stroke color.

For any shape, if there is a color in Fill property or Line/Stroke property, color the respective property Fill or Line/Stroke as per the application order defined.
If for any shape, both Fill and Line/Stroke property are set with the same color, treat it as current z-order and color both the same.
If a shape has Line and Fill property set with different colors, consider Fill as current z-order shape, Line/Stroke as next z-order shape, and follow the color application order.
Identify if white or black has been inherited for any shapes (both Stroke and Fill). If yes, follow below for each one of those shapes.

```
If L3 (L of Color3) ≤ 85
  If L3 ≥ 45
    Stroke/Fill = Retain from original (whether black or white)
  Else Stroke/Fill = White; oklch(100% 0 0)
Else
  Stroke/Fill = Black; oklch(0% 0 0)
```

If there is no white or black inherited for any shape, proceed individually only for those shapes that are not white or black.
   Sort the list of shapes in increasing z-order.
      All shapes with same color (even with differing opacity/alpha) are assigned the z-order of its' lowest z-order element.
   Start with the shape lowest in the z-order (closer to background)
      For shape 1 (and all shapes with same color) do the following:
Is there a text element that has the same color as Shape 1 in the original artifact? If yes, skip this shape and move to Shape 2.
   If no, follow below for coloring.

```
If(IsUserIntentColor = True)
    Shape 1 = Color1 (Soft Highlight Color)
      Else If (H3 ≤ 115⁰) && (H3 ≥ 330⁰); //warm
    If ((FG_ColorCount ≤ 3) && (ContstantsStyle_Name ≠ ‘ConstantsStyle_Monotone’)
      If Background coloring was skipped
        Shape 1 = Color1 (Soft Highlight Color)
      Else Shape 1 = Color4 (Sharp Shadow Color)
    Else
      Shape 1 = Color1 (Soft Highlight Color)
  Else If (H3 ≤ 330⁰) && (H3 ≥ 115⁰); //cool
    If ((FG_ColorCount ≤ 3) && (ContstantsStyle_Name ≠ ‘ConstantsStyle_Monotone’)
      If Background coloring was skipped
        Shape 1 = Color5 (Soft Shadow Color)
      Else Shape 1= Color2 (Sharp Highlight Color)
    Else
      Shape 1= Color5 (Soft Shadow Color)
```

For shape 2 (and all shapes with same color), use the following algorithm.
Is there a text element that has the same color as Shape 2 in the original artifact? If yes, skip this shape and move to Shape 3.
   If no, follow below for coloring.

```
If(IsUserIntentColor = True)
    Shape 2 = Color2 (Sharp Highlight Color)
Else If (H3 ≤ 115⁰) && (H3 ≥ 330⁰); //warm
  If ((FG_ColorCount ≤ 3) && (ContstantsStyle_Name ≠ ‘ConstantsStyle_Monotone’)
    If Background coloring was skipped
      Shape 2 = Color4 (Sharp Shadow Color)
  Else
    Shape 2 = Color5 (Soft Shadow Color)
  Else If (H3 ≤ 330⁰) && (H3 ≥ 115⁰); //cool
  If ((FG_ColorCount ≤ 3) && (ContstantsStyle_Name ≠ ‘ConstantsStyle_Monotone’)
    If Background coloring was skipped
      Shape 2 = Color2 (Sharp Highlight Color)
  Else
    Shape 2 = Color1 (Soft Highlight Color)
```

For shape 3 (and all shapes with same color), in an example, the following algorithm is used.
Is there a text element that has the same color as Shape 3 in the original artifact? If yes, skip this shape and move to Shape 4.
   If no, follow below for coloring.

```
If(IsUserIntentColor = True)
    Shape 3 = Color4 (Sharp Shadow Color)
Else If (H3 ≤ 115⁰) && (H3 ≥ 330⁰); //warm
  Shape 3 = Color2 (Sharp Highlight Color)
If (H3 ≤ 330⁰) && (H3 ≥ 115⁰); //cool
  Shape 3 = Color4 (Sharp Shadow Color)
```

For shape 4 (and all shapes with same color), in another example, the following algorithm may be used.
Is there a text element that has the same color as Shape 4 in the original artifact? If yes, skip this shape and move to coloring all text.
   If no, follow below for coloring.

```
  Shape 2 = Color2 (Sharp Highlight Color)
If(IsUserIntentColor = True)
  Shape 4 = Color5 (Soft Shadow Color)
Else If (H3 ≤ 115⁰) && (H3 ≥ 330⁰); //warm
  Shape 4 = Color4 (Sharp Shadow Color)
Else If (H3 ≤ 330⁰) && (H3 ≥ 115⁰); //cool
  Shape 4 = Color2 (Sharp Highlight Color)
```

For text colors, in an example artifact which includes an image, text and a limited number of shapes, the color application engine 212 may utilize the following algorithm to determine the text color.
Does the textbox boundary overlap with the image completely?
   If yes, apply the lightness and chroma interpolation algorithm discussed above to text that is over an image or overlaps with an image.
Else if the textbox boundary overlaps partially with image and shapes:
   Determine percentage of overlap of textbox with image and non-image
      If percentage of overlap on image >67%, apply the lightness and chroma interpolation algorithm.
      Else proceed with the following rules.
Identify if white or black has been inherited for any text, if yes follow below for each of those textboxes.

```
If background shape L ≤ 85
  If L ≥ 55
    Foreground = Retain from original (whether black or white)
  Else Foreground = White; oklch(100% 0 0)
Else
  Foreground = Black; oklch(0% 0 0)
```

If no black or white is inherited from original, if a shape was skipped coloring due to same color as text, calculate the text color as below and apply the same color to the specific shape.
If background element is using Color1 OR Color2

```
  Heading foreground = Color7 (Accent Highlight Color)
  Subheading foreground = Heading Color L + 2xDeltaL, C, H
  Body foreground = Heading Color L + 2xDeltaL, C, H
If background element is using Color3 (OR) if background element is not yet defined
  If (H3 ≤ 115⁰) && (H3 ≥ 330⁰); //warm
    Heading foreground = Color7 (Accent Highlight Color)
      H = H of Color7
      L = 100 − L3
        If (L ~ L3) < 6xDeltaL ; ~ is difference
          Then L = L3 + 2xDeltaL; up to MaxL
        If L ≤ MinL, increase to L = L + 2xDeltaL
      C = 0.24 − C3
    Subheading foreground = Heading Color L + 2xDeltaL, C, H
    Body foreground = Heading Color L + 2xDeltaL, C, H
  If (H3 ≤ 330⁰) && (H3 ≥ 115⁰); //cool
    Heading foreground = Color6 (Accent Shadow Color)
      H = H of Color6
      L = 100 − L3
        If (L ~ L3) < 6xDeltaL ; ~ is difference
          Then L = L3 + 2xDeltaL; up to MaxL
        If L ≤ MinL, increase to L = L + 2xDeltaL
      C = 0.24 − C3
    Subheading foreground = Heading Color (L + 2DeltaL), C, H
    Body foreground = Heading Color L + 2xDeltaL, C, H
```

If background element is using Color4 OR Color5
   Heading foreground=Color6 (Accent Shadow Color)
   Subheading foreground=Heading Color L+2×DeltaL, C, H
   Body foreground=Heading Color L+2×DeltaL, C, H

In summary, depending on the types and number of elements in the artifact and their relationship with each other, the base palette generation engine 210 utilizes a number of rules and algorithms to recolor some or all of the elements in the artifact based on the colors in the base palette to achieve an aesthetically pleasing artifact. It should be noted that the above provided algorithms are only examples and many other types of rules and algorithms may be used to achieve the desired results. The resulting recolored artifact is provided as output 220. In some implementations, the recolored artifact 204 includes the image 202 as desired/inserted by the user such that the output 220 includes the combination of the image 202 and the artifact 204 in a recolored harmonious result. In another implementation, the output 220 is simply the recolored artifact and the user can choose how to insert the image 202 after reviewing the results. The output 220 is provided to the application 112/114 from which the request was received and is displayed in a user interface of the application to the user.

FIG. 3A depicts an alternative implementation in which two input images are received. In some implementations, the user intends to insert two or more images in an artifact to create a desired design. In an example, these images are first image 302 and second image 305. As discussed above with respect to FIG. 2, the images may be received from the user or may be selected by the user. The artifact 304 may also be user selected. Once the images and the artifact are received by the recoloring engine 146, the images are transmitted to the color map engine 306, which operates in a similar manner as the color map engine 206 of FIG. 2 to extract colors from the input images 302 and 304. In some implementations, the color map engine 306 extracts the colors separately from each of the first image 302 and the second image 305 to generate a global color list for each image as discussed above. Once the list of global colors is obtained for each image, the separate color lists are concatenated into a single list. This may be achieved by simply combining the two lists. The concatenated list is then transmitted to the global color extraction engine 308 to filter out neutral colors as discussed above to generate a global color palette which is then transmitted to the base palette generation engine 310. The global color extraction engine 308 operates in a similar manner as the global color extraction engine 208 of FIG. 2 and the base palette generation engine 310 operates in a similar manner as the base palette generation engine 210 of FIG. 2. Thus, the base palette generation engine 310 utilizes the received color palette to generate a base palette. This generated base palette incorporates colors from both input images 302 and 304, thus taking into account colors from both images. In some implementations, the base palette generation engine 310 identifies a palette of 7 compatible colors which are then transmitted to the color application engine 312. The color application engine 312 operates in a similar manner as the color application engine 212 of FIG. 2 to recolor the artifact 304 based on the identified base palette colors. Once recoloring is complete, the color application engine 312 transmits the output 326 which is the recolored artifact (which may include the input images 302 and 304) to the application 112/114 for display to the user.

FIG. 3B depicts an alternative implementation in which in addition to the input image, a user query is also received. The user query 320 may be received via a user interface of the application from which the user request for inserting an image 324 into an artifact 326 is received. The user query may be in natural language and may identify the intent of the user for the design. For example, the user query may state “a design for mediation week in pink and yellow colors.” Thus, the user query may identify the purpose of the design as well as one or more desired colors. The user query 320 is submitted to a prompt construction engine 362 which constructs a prompt for transmission to a generative model 322, in some implementations, for processing. The generative model 322 may be a large language model (LLM). Examples of such models include but are not limited to a Generative Pre-trained Transformer 3 (GPT-3), or GPT-4 model. Other implementations may utilize other models or other generative models. The generative model 322 is a model that is trained to determine the user's intent and color needs based on the user query and provide an output of a few identified colors based on the user query. In an example, the generative model 322 outputs a few colors (e.g., 4 or 5 colors) as well as the hex code which the model determines is usable in a design. The colors output by the generative model 322 are then provided to the base color generation engine 310 which uses the colors in the same manner as the global color palette discussed with respect to FIG. 2 to generate a base color palette. Thus, the base color generation engine 310 operates in a similar manner as the base color generation engine 210 to generate a base palette. In some implementations, in addition to the colors identified by the generative model 322, colors are also extracted from the image 332 in the manner discussed in FIG. 2 (e.g., using a color map engine and/or a global color extraction engine) and the two color lists are combined/concatenated to generate one color list which is then transmitted to the base palette generation engine 310.

The base palette is transmitted to the color application engine 312, which operates in a similar manner as the color application engine 212 of FIG. 2 to recolor the artifact 326 based on the identified base palette colors. Once recoloring is complete, the color application engine 312 transmits the output 362 which is the recolored artifact to the application 112/114 for display to the user.

FIG. 3C depicts an alternative implementation in which the user query includes a desired mood for the design. The user query 328 may be received via a user interface of the application from which the user request for creating a design using an artifact 334 is received. The user query may be in natural language and may identify a desired mood or style for the design. For example, the user query may state “an elegant design for birthday party invitation week in pink and yellow colors.” Thus, the user query may identify the desired mood/style of the design as well as one or more desired colors. The user query 328 is transmitted to the prompt construction engine 362 which generates a prompt in format suitable for transmission to a generative model 330 for processing. The generative model 330 may be an LLM or another type of AI model. Examples of such models include but are not limited to a Generative Pre-trained Transformer 3 (GPT-3) or GPT-4 model. Other implementations may utilize other models or other generative models. The generative model 330 may be a model that is trained to determine the user's color needs based on the user query and provide an output of the user's desired intent based on the user query. In an example, the generative model 330 outputs a specific image style based on the user query (e.g., modern, etc.). The identified style is then provided to a style to palette mapping engine 336. The style to palette mapping engine 336 may be a classifier or may use heuristics to map a number of colors to each identified style. The mapped colors are then provided to the base color generation engine 310 which uses the colors in the same manner as the global color palette discussed with respect to FIG. 2 to generate a base color palette. In some implementations, in addition to the colors identified by the style to palette mapping engine 336, colors are also extracted from the image 332 in the manner discussed in FIG. 2 and the two color lists are combined/concatenated to generate one color list which is then transmitted to the base palette generation engine 310. The base color generation engine 310 operates in a similar manner as the base color generation engine 208 to generate a base palette.

The base palette is transmitted to the color application engine 312, which operates in a similar manner as the color application engine 212 of FIG. 2 to recolor the artifact 334 based on the identified base palette colors. Once recoloring is complete, the color application engine 312 transmits the output 336 which is the recolored artifact (which may include the input image 332) to the application 112/114 for display to the user.

FIG. 3D depicts an alternative implementation in which instead of an image, a video file is received for incorporation with an artifact. In some implementations, the user intends to insert a video (e.g., short video clip, animation, GIF, etc.) in an artifact to create a desired design. In an example, the video 340 is uploaded or otherwise selected by the user for insertion into the artifact 342. Once the video 340 and artifact 342 are received by the recoloring engine 146, the video 340 is transmitted to the color map engine 306, which operates in a similar manner as the color map engine 206 of FIG. 2 to extract colors from each video frame of the video 340. This may require some pre-processing to parse the video 340 into its video frame. The parsed video frames are then treated in a similar manner as individual images. The color map engine 306 extracts the colors separately from each of the video frames to generate a global color list for each video frame as discussed above. Once the list of global colors is obtained for each video frame, the separate color lists are concatenated into a single list. The concatenated list is then transmitted to the global color extraction engine 308 to filter out neutral colors as discussed above to generate a global color palette which is then transmitted to the base palette generation engine 310. The global color extraction engine 308 operates in a similar manner as the global color extraction engine 208 of FIG. 2 and the base palette generation engine 310 operates in a similar manner as the base palette generation engine 210 of FIG. 2. Thus, the base palette generation engine 310 utilizes the received color palette to generate a base palette. The generated base palette incorporates colors from multiple (e.g., all) video frames, thus taking into account colors from the video. In some implementations, the base palette generation engine 310 identifies a palette of 7 compatible colors which are then transmitted to the color application engine 312. The color application engine 312 operates in a similar manner as the color application engine 212 of FIG. 2 to recolor the artifact 342 based on the identified base palette colors. Once recoloring is complete, the color application engine 312 transmits the output 344 which is the recolored artifact (which may include the input video 340) to the application 112/114 for display to the user.

FIG. 3E depicts an alternative implementation in which a multimodal model is used to infer user intent and image context. The user query 350 may be received via a user interface of the application from which the user request for inserting an image 354 into an artifact 356 is received. The user query may be in natural language and may identify the intent of the user for the design. For example, the user query may state “a design for a product launch in muted pink and yellow.” The user query 350 as well as the input image 354 are then submitted to a multimodal model 352, for processing. The multimodal model 352 may be a model design to process both text and images. Examples of such models include but are not limited to a e.g., GPT V model. Other implementations may utilize other models or other generative models. The multimodal model 352 is a model that is trained to determine the user's intent and color needs based on the user query and as well as input image context to provide an output of contextual relevant colors based on the input. The colors output by the multimodal model 352 are then provided to the base color generation engine 310 which uses the colors in the same manner as the global color palette discussed with respect to FIG. 2 to generate a base color palette. Thus, the base color generation engine 310 operates in a similar manner as the base color generation engine 208 to generate a base palette.

The generated base palette is transmitted to the color application engine 312, which operates in a similar manner as the color application engine 212 of FIG. 2 to recolor the artifact 356 based on the identified base palette colors. Once recoloring is complete, the color application engine 312 transmits the output 360 which is the recolored artifact to the application 112/114 for display to the user. This implementation may be used to recolor a design based on the basis of a product's or company's brand colors. For example, the user query may specify the colors in the brand and an image of the brand may also be transmitted for processing.

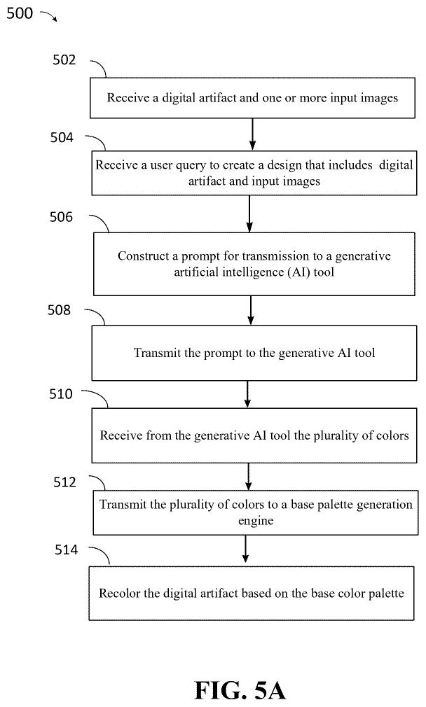

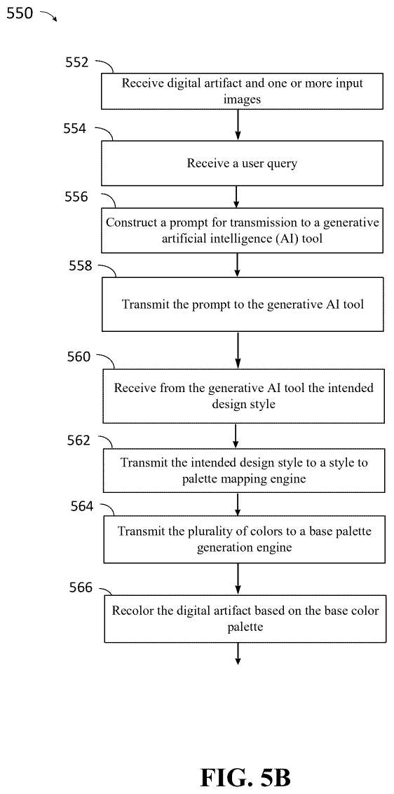

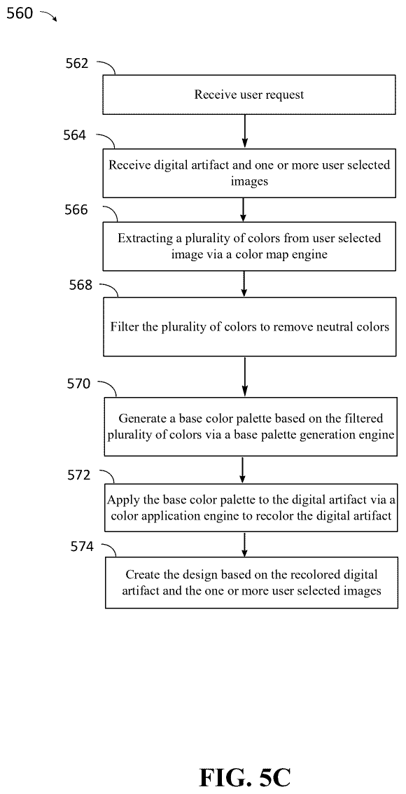

FIG. 5A is a flow diagram depicting an exemplary method 500 for automatically recoloring an artifact based on one or more input parameters. At least some of the steps of method 500 are performed by a recoloring engine such as the recoloring engine 146 of FIGS. 1, 2 and 3A-3E and/or a generative model such as the generative model 322, generative model 330 and generative model 352 of FIGS. 3B, 3C and 3E. Method 500 begins and proceeds to receive the digital artifact and one or more input images, at 502. The digital artifact may be a template and the one or more input images are images that are user provided or provided by an application and are intended to be incorporated into the artifact to create a design.

After receiving the digital artifact and one or more input images, a user query is received from a user interface screen of an application being executed on a user client device, at 504, the user query being related to creating a design that includes the digital artifact and the one or more input images. The user query may be in natural language and may specify a user intent for the design and/or one or more colors the user is interested in using. After receiving the user query, a prompt is constructed, via a prompt construction engine, for submission to a generative AI tool, at 506. The prompt requests the generative AI tool to identify a plurality of colors based on the user query. The generative AI tool may be a LLM, a GPT or a multimodal model. The constructed prompt is then transmitted to the generative AI tool, at 508.

In response, a plurality of colors that are selected by the generative AI tool as corresponding with the user query and/or input images is received from the generative AI tool, at 510. The colors may be colors that correspond with the user intent, with the colors input by the user and/or the colors extracted from the one or more input images. When the generative AI tool is a multimodal model, the prompt to the generative AI tool includes the user query and the input images and the generative AI tool identifies the plurality of colors based on the user query and colors of the one or more images. When the generative AI tool is not a multimodal model, each of the one or more input images is transmitted to a color map engine which extracts colors from each of the one or more input images to generate a global color list for each image. The global color list is then concatenated with the colors provided by the generative AI tool to create a final global color list.

The final global color list or the plurality of colors received from the generative AI tool are transmitted to a base palette generation engine, at 512. The base palette generation engine generates a base color palette based on at least one of one or more colors of the one or more input images or the plurality of colors received from the generative AI tool. The generated base color palette is then used to recolor the digital artifact based on the base color palette, at 514. The recolored artifact may then be used to generate a final design with includes the one or more input images.

FIG. 5B is a flow diagram depicting an exemplary method 550 for automatically recoloring a digital artifact to generate an aesthetically pleasing design. At least some of the steps of method 550 are performed by a recoloring engine such as the recoloring engine 146 of FIGS. 1, 2 and 3A-3E and/or a generative model such as the generative model 322, generative model 330 and generative model 352 of FIGS. 3B, 3C and 3E. Method 500 begins and proceeds to receive the digital artifact and one or more input images, at 552. The digital artifact may be a template and the one or more input images are images that are user provided or provided by an application and are intended to be incorporated into the artifact to create a design.

After receiving the digital artifact and one or more input images, a user query is received from a user interface screen of an application being executed on a user client device, at 554, the user query indicating a desire to generate the design, the design including the digital artifact and the one or more input images. The user query may be in natural language and may specify a user intent or mood for the design. After receiving the user query, a prompt is constructed, via a prompt construction engine, for submission to a generative AI tool, at 556. The prompt requests the generative AI tool to identify an intended design style based on the user query. The generative AI tool may be a LLM, a GPT or a multimodal model. The constructed prompt is then transmitted to the generative AI tool, at 558.

In response, intended design style that corresponds with the user request mood/intent is received from the generative AI tool, at 560. The intended design style is then transmitted to a style to palette mapping engine to identify a plurality of colors that correspond to the intended design style, at 562. In response, the style to palette mapping engine provides a list of colors that correspond with the style. In some implementations, each of the one or more input images are also transmitted to a color map engine which extracts colors from each of the one or more input images to generate a global color list for each image. The global color list is then concatenated with the colors provided by the style to palette mapping engine to create a final global color list.

The final global color list or the list of colors received from the style to palette mapping engine are transmitted to a base palette generation engine, at 564. The base palette generation engine generates a base color palette based on at least one of one or more colors of the one or more input images or list of colors received from the style to palette mapping engine. The generated base color palette is then used to recolor the digital artifact based on the base color palette, at 566. The recolored artifact may then be used to generate a final design with includes the one or more input images.

FIG. 5C is a flow diagram depicting another exemplary method for automatically recoloring an artifact based on one or more input parameters. At least some of the steps of method 560 are performed by a recoloring engine such as the recoloring engine 146 of FIGS. 1, 2 and 3A-3E and/or an application such as applications 112/114 of FIG. 1. Method 560 begins and proceeds to receive a user request to create a design that incorporates one or more user selected images into a digital artifact, at 562. The user request is received from a user interface screen of an application being executed on a user client device. The user request may be received when the user provides/selects an image to insert into a digital artifact such as a template.

After receiving the user request, the digital artifact and one or more user selected images are received, at 564. The one or more images are images that are user provided or provided by an application and are intended to be incorporated into the artifact to create a design. In some implementations, the digital artifact and the user selected images are received with the user request.

Method 560 then proceeds to extract a plurality of colors from each of one or more user selected images via a color map engine, at 566. In some implementations, the color map engine creates a color-based segmentation of each of the one or more images to obtain information about colors present in the image and a location of the present colors. The extracted colors are then filtered to remove neutral colors, at 568. This may involve removing colors such as black and gray. In some implementations, the extracted colors are provided to a global color extraction engine which generates a global color frequency list of image colors.

After filtering the colors and/or generating the global color frequency list of image colors, a base color palette is generated based on the filtered plurality of colors via a base palette generation engine, at 570. The base color palette is then applied to the digital artifact via a color application engine to recolor the digital artifact, at 572. This involves recoloring one or more elements of the digital artifact based on the base color palette. Method 560 then proceeds to create the design based on the recolored digital artifact and the one or more user selected images.

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as client devices, native application providers, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764 such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-7) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

What is claimed is:

1. A data processing system for automatically recoloring a digital artifact, the data processing system comprising:
a processor; and
a memory in communication with the processor, the memory comprising executable instructions that, when executed by the processor alone or in combination with other processors, cause the data processing system to perform functions of:
receiving the digital artifact and one or more input images;
receiving a user query, from a user interface screen of an application being executed on a user client device, to create a design that includes the digital artifact and the one or more input images;
constructing a prompt, via a prompt construction engine, for transmission to a generative artificial intelligence (AI) tool, the prompt requesting the generative AI tool to identify a plurality of colors based on the user query;
transmitting the prompt to the generative AI tool;
receiving from the generative AI tool the plurality of colors; and
transmitting the plurality of colors to a base palette generation engine, the base palette generation engine generating a base color palette based on at least one of one or more colors of the one or more input images and the plurality of colors received from the generative AI tool; and
recoloring the digital artifact based on the base color palette.

2. The data processing system of claim 1, wherein the generative AI tool is a large language model.

3. The data processing system of claim 1, wherein:
the generative AI tool is a multimodal model,
the prompt to the generative AI tool includes the user query and the one or more images, and
the generative AI tool identifies the plurality of colors based on the user query and colors of the one or more images.

4. The data processing system of claim 1, wherein the generative AI tool identifies a color theme based on at least one of the user query and the one or more input images.

5. The data processing system of claim 1, wherein the base palette generation engine generates the base color palette based on heuristics applied to the plurality of colors.

6. The data processing system of claim 1, wherein the base color palette includes 7 colors.

7. The data processing system of claim 1, wherein each of the one or more input images is transmitted to a color map engine which extracts colors from each of the one or more input images to generate a global color list for each image.

8. The data processing system of claim 7, wherein the global color list is filtered to remove neutral colors.

9. The data processing system of claim 8, wherein the global color list is combined with the plurality of colors to generate a combined color list for transmission to the base palette generation engine.

10. The data processing system of claim 1, wherein recoloring the digital artifact includes recoloring one or more elements of the digital artifact based on the base color palette in accordance with heuristics.

11. A method for automatically recoloring a digital artifact to generate an aesthetically pleasing design, the method comprising:
receiving the digital artifact and one or more input images;
receiving a user query, from a user interface screen of an application being executed on a user client device, the user query indicating a desire to generate the design, the design including the digital artifact and the one or more input images;
constructing a prompt, via a prompt construction engine, for transmission to a generative artificial intelligence (AI) tool, the prompt requesting the generative AI tool to identify an intended design style based on the user query;
transmitting the prompt to the generative AI tool;
receiving from the generative AI tool the intended design style;
transmitting the intended design style to a style to palette mapping engine to identify a plurality of colors that correspond to the intended design style;
transmitting the plurality of colors to a base palette generation engine, the base palette generation engine generating a base color palette based on at least one of one or more colors of the one or more input images or the plurality of colors received from the style to palette mapping engine; and
recoloring the digital artifact based on the base color palette.

12. The method of claim 11, wherein the generative AI tool is a large language model.

13. The method of claim 11, wherein the generative AI tool is a Generative Pre-trained Transformer.

14. The method of claim 11, wherein the digital artifact is a template.

15. A non-transitory computer readable medium on which are stored instructions that, when executed, cause a programmable device to perform functions of:
receiving a user request, from a user interface screen of an application being executed on a user client device, to create a design that incorporates one or more user selected images into a digital artifact;
receiving the digital artifact and the one or more user selected images;
extracting a plurality of colors from each of one or more user selected images via a color map engine;
filtering the plurality of colors to remove neutral colors;
generating a base color palette based on the filtered plurality of colors via a base palette generation engine;
applying the base color palette to the digital artifact via a color application engine to recolor the digital artifact based on the base color palette; and
creating the design based on the recolored digital artifact and the one or more user selected images.

16. The non-transitory computer readable medium of claim 15, wherein the color map engine creates a color-based segmentation of each of the one or more images to obtain information about colors present in the image and a location of the present colors.

17. The non-transitory computer readable medium of claim 15, wherein the plurality of colors are provided to a global color extraction engine which generates a global color frequency list of image colors.

18. The non-transitory computer readable medium of claim 15, wherein the base palette generation engine generates the base color palette based on heuristics applied to the filtered plurality of colors.

19. The non-transitory computer readable medium of claim 15, wherein the color application engine recolors one or more elements of the digital artifact based on the base color palette.

20. The non-transitory computer readable medium of claim 15, wherein the plurality of colors from each of the one or more images are combined to generate one color list.
